(19) United States
(12) Patent Application Publication
(10) Pub. No.: US 2008/0143823 A1
(43) Pub. Date: Jun. 19, 2008

(54) SYSTEM AND METHOD FOR PROVIDING STEREO IMAGE

(76) Inventors: Sang-Hoon Jin, Suwon-si (KR); Su-Yeul Lee, Suwon-si (KR); Jun-Young Jung, Yongin-si (KR)

Correspondence Address: CHA & REITER, LLC, 210 ROUTE 4 EAST STE 103, PARAMUS, NJ, 07652, US

(21) Appl. No.: 11/955,464

(22) Filed: Dec. 13, 2007

(30) Foreign Application Priority Data
Dec. 13, 2006 (KR) 127122/2006

(51) Int. Cl. H04N 13/00; H04N 13/04

(52) U.S. Cl. 348/44; 348/51; 348/46; 382/154; 348/E13.001; 348/E13.075; 348/E13.026; 348/E13.06

(57) ABSTRACT

A system includes a stereo image creation device for converting image data created by image detectors into stereo image data, receiving sounds collected by microphones so as to create sound data from the received sounds, creating stereo moving image data containing the stereo image data, the sound data, and synchronization information necessary to synchronize them, and transmitting the stereo moving image data via a communication network and a stereo image output device for receiving the stereo moving image data via the communication network, separating the stereo image data, sound data, and synchronization information from the stereo moving image data, synchronizing the stereo image data with the sound data according to the synchronization information, and outputting the stereo image data and the sound data via output units so that a performance is simulated at a remote place.

### CLAIM OF PRIORITY

This application claims the benefit of the earlier filing date, under 35 U.S.C. §119(a), to that patent application entitled “System and Method for Providing Stereo Image,” filed in the Korean Intellectual Property Office on Dec. 13, 2006 and assigned Serial No. 2006-127122, the contents of which are hereby incorporated by reference.

### BACKGROUND OF THE INVENTION

1. Field of the Invention

The present invention relates to a data transmission service, and more particularly to a method and a system for providing stereo images simulating a performance held at a remote place.

2. Description of the Related Art

Various entertainments are held with regard to major events (e.g., World Cup 2006), and supporters fill streets, as well as stadiums. Large screens or projectors are installed to display game scenes to street supporters who cheer for their favorite team. However, conventional projectors or large screens have a limitation in that they merely display planar images, i.e. they cannot convey the excitement occurring in the stadiums by displaying stereo images.

### SUMMARY OF THE INVENTION

The present invention provides a method and a system for providing stereo images simulating a performance held at a remote place for realistic video/audio experiences.

In accordance with an aspect of the present invention, there is provided a system for providing stereo images, the system including a stereo image creation device implemented at a first place to photograph a performance held at the first place, the stereo image creation device converting image data created by a number of image detectors (at least one) positioned at the first place into three-dimensional stereo image data, receiving sounds collected by a number of microphones (at least one), creating stereo moving image data containing the stereo image data, the sound data, and synchronization information necessary to synchronize the stereo image data with the sound data, and transmitting the stereo moving image data via a communication network or a broadcasting network; and a stereo image output device placed at a second place, the stereo image output device receiving the stereo moving image data via the communication network or the broadcasting network, separating the stereo image data, the sound data, and the synchronization information from the stereo moving image data, synchronizing the stereo image data with the sound data according to the synchronization information, and outputting the stereo image data and the sound data via a number of output units so that stereo moving images simulating a performance held at the first place are outputted at the second place.

### BRIEF DESCRIPTION OF THE DRAWINGS

The above and other aspects, features and advantages of the present invention will be more apparent from the following detailed description taken in conjunction with the accompanying drawings, in which:

FIG. 1 shows a process for providing stereo images according to an embodiment of the present invention;

FIG. 2 shows the construction of a system for providing stereo images according to a first embodiment of the present invention;

FIGS. 3 and 4 show how stereo images are created by a stereo image creation apparatus according to a second embodiment of the present invention;

FIG. 5 shows the construction of an apparatus for creating stereo images simulating a performance according to an embodiment of the present invention;

FIG. 6 shows the construction of a creation processor according to an embodiment of the present invention;

FIG. 7 shows the construction of an apparatus for outputting stereo images simulating a performance according to an embodiment of the present invention; and

FIG. 8 shows the construction of an output processor according to an embodiment of the present invention.

### DETAILED DESCRIPTION OF THE INVENTION

Exemplary embodiments of the present invention are described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it is apparent to those skilled in the art that the present invention can be implemented without such definitions. Further, in the following description of the present invention, a detailed description of known functions and configurations incorporated herein are omitted when it may make the subject matter of the present invention unclear.

The present invention proposes an apparatus and a method for providing three-dimensional (i.e. stereoscopic) images. As used herein, stereo images refer to three-dimensional data simulating actual objects in a three-dimensional space. For example, the stereo images may be holograms realistically simulating objects at various angles in a three-dimensional space.

The present invention utilizes holography, stereoscopic photography, or conventional photography so as to obtain video and audio data from a performance (e.g. sport game or event). The data is transmitted in real time to a place remote from the performance and is regenerated stereoscopically so that the audience can watch stereo images simulating the performance in a realistic manner.

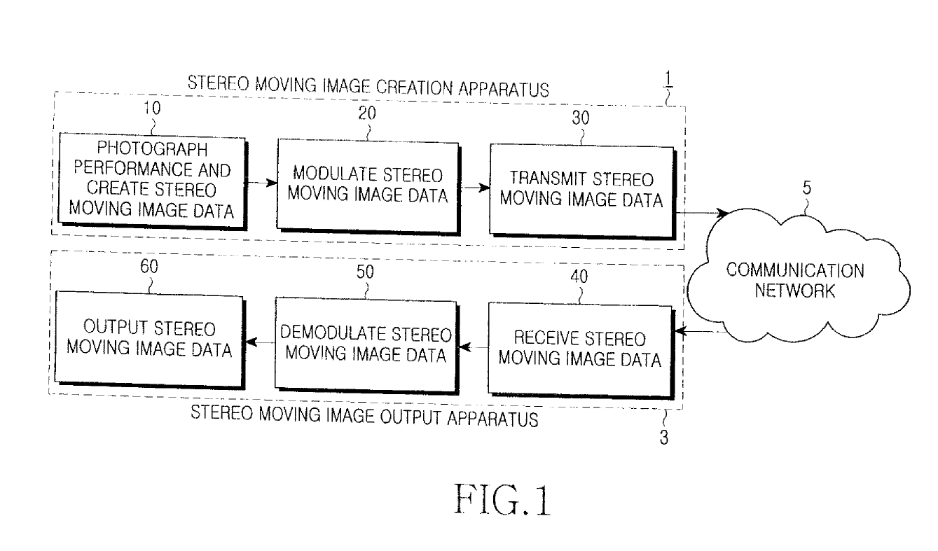

A system for providing stereo images according to the present invention will now be described with reference to FIG. 1 together with a process for providing stereo images. A system for providing stereo images according to the present invention includes a stereo image creation apparatus 1, a stereo image output apparatus 3, and a communication network 5 or a broadcasting network. The stereo image creation apparatus 1 is adapted to create stereo image data and sound data regarding specific objects in a performance and synchronize the data so as to create stereo moving image data. Alternatively, data for synchronizing the stereo image data with the sound data is added to these pieces of data to create the stereo moving image data. A plurality of microphones may be used to create and transmit stereo sound data. Images can be obtained not only by stereoscopic photography specially designed to take stereo images, but also by conventional photography adapted to take stereo images. For example, stereo image data can be created by using a reference beam and an object beam (i.e. according to holography). Alternatively, a number of cameras may be used to photograph an object according to the principle of binocular disparity. The sound data may be either stereo sounds created in a multi-channel sound mode, for example, or conventional sounds. In another aspect it is also possible to assign a camera to each object and photograph it.

The stereo image creation apparatus 1 is positioned at a first site (e.g. stadium, theater, open field), in which a performance is held, so as to create stereo moving image data. The stereo image creation apparatus 1 modulates the created stereo moving image data according to the transmission mode and transmits the data to the stereo image output apparatus 3 via the communication network 5. In this case, the communication network may be an IP-type network (i.e., intranet or internet) or a telephone network (DSL) or may be a broadcasting network. Similarly, the communication network 5 may be a combination of IP Protocol (Internet), DSL and/or broadcasting networks. In addition other types of communication networks (and combinations thereof) can be used to transmit the stereo moving image data, including wired telephone networks, wired/wireless IP networks, mobile communication networks, analog broadcasting networks, digital broadcasting networks, as well as satellites.

The stereo image output apparatus 3 demodulates the received stereo moving image data and outputs the resulting stereo image data and sound data after synchronizing them. The stereo image data may be outputted in a holographic output mode or a binocular disparity-based output mode. Alternatively, a projector having at least two light sources (lasers or visible rays) may be used so that light from the light sources (lasers or visible rays) interferes with each other and creates stereo images in a space. It is also possible to make use of the scattering of light to express stereo images. If technology capable of implementing stereo images by using a single light source is developed in the near future, this technology could be used to express stereo images and is contemplated to be within the scope of the invention. The outputted stereo images may have a size equal to that of the actual object or proportional to it. The stereo image output apparatus 3 is installed at a place where an audience is expected to watch a performance (e.g. playground, indoor theater, race track, movie theater). When a plurality of microphones are used to pick up sounds, it is possible to create stereo sound data by combining the detected sounds into an audio data stream, transmitting the audio data, and provide stereo sounds synchronized with outputted images. Alternatively, a single microphone may be used to pick up sound data, encode it into stereo sound data, transmit the data, and output stereo sounds from the output means. As such, the number of microphones is not limited in the present invention. If conventional sounds are picked up by microphones, they may be transmitted and outputted as they are. However, it is preferred to create and output stereo sounds for realistic experiences.

The above-mentioned system according to the present invention provides stereo images in the following manner: the stereo image creation apparatus 1 photographs a performance (e.g. sporting event) and creates stereo image data and sound data in block 10. The sound data includes at least one piece of sound data, and may be used to create stereo sounds. The stereo image creation apparatus 1 creates stereo moving image data, which include stereo image data, sound data, and information necessary to synchronize the stereo image data with the sound data, and modulates the data according to the transmission mode in block 20. The stereo image creation apparatus 1 transmits the stereo moving image data to the stereo image output apparatus 3 via the communication network 5 according to the communication mode in block 30. The stereo image output apparatus 3 receives the stereo moving image data, demodulates it, and outputs corresponding three-dimensional (i.e. stereoscopic) images and multi-channel sounds. As a result, the audience feels like they are watching the performance (e.g. sport, play) at the location of performance.

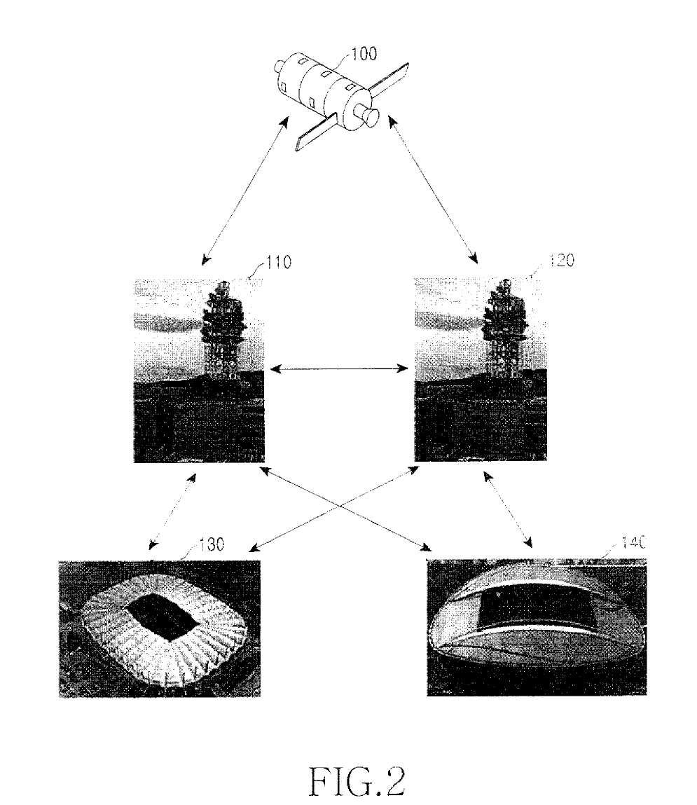

FIG. 2 shows the construction of a system for providing stereo images according to a first embodiment of the present invention. FIG. 2 illustrates an example of creating stereo moving image data according to holography. Holograms may be similar to photographs from a technical point of view, but the main difference is that holograms look just like actual objects as they are three-dimensional in nature. Holography, which was invented by Dennis Gabor in 1947, is well-known in the art.

According to the principles of holography, beams from a laser are split into two: one of which directly illuminates the screen and is referred-to as a reference beam. The other beam illuminates a target object and is referred-to as an object beam. The object beam, which is reflected on each surface of the object, experiences different phases depending on the surface, and as the distance between the surface and the screen varies. The reference beam, which remains unchanged, interferes with the object beam. The resulting interference pattern appears on the screen, and is stored as stereo image data.

A beam used to regenerate holograms has the same frequency as the beam used for recording. Particularly, corresponding waves are solely regenerated three-dimensionally, and waves with different wavelengths and phases pass through the stored holograms with no influence on it. Therefore, the regeneration beam must be identical to the reference beam. The main difference between holograms and conventional photographs is that the same beam must be used for recording and regeneration and that three-dimensional images are produced. This is because, unlike two-dimensional images storing the strength of the object beam only, holograms additionally store the direction of the beam. It has been impossible until holography was invented to watch three-dimensional images without wearing stereoscopic glasses or using a complicated device mounted on a computer. However, the arrival of holography has made it possible to conveniently watch three-dimensional images at any angle.

FIG. 2 illustrates a system for providing stereo images based on holography or any type of available technology for creating stereo images according to a first embodiment of the present invention. In order to produce holograms of a performance (e.g. sport game, event), a data input apparatus is installed at the place where the performance is held so as to collect data regarding the motion, position, etc. of objects appearing in the performance. Although the system according to the present invention can be used for various types of performances, it will be assumed in the following description that the system is used for a soccer game for convenience.

The stereo image creation apparatus 1 (FIG. 1) has a hologram creation unit positioned in the transmission-side stadium 130, where the soccer game is held, so as to create hologram data corresponding to stereo image data. Particularly, the stereo image creation apparatus 1 includes a beam splitter for splitting lasers from a laser source into a reference beam and an object beam; mirrors for reflecting the reference and object beams, respectively, an optical device panel adapted to allow only the object beam, which has been reflected by a target object, to pass through and an optical device positioned at a place where the object beam and the reference beam are collected so as to store the interference pattern between the reference and object beams. In addition, the stereo image creation apparatus 1 has an audio unit for creating multi-channel sound data. As such, the stereo image creation apparatus 1 creates hologram data and sound data by using the hologram creation unit and the audio unit, respectively. Then, the stereo image creation apparatus 1 creates image data including information necessary to synchronize both pieces of data and transmits it to a transmission-side relay station 110, which transmits data from the stadium 130 to the destination via a satellite 100. Although it is assumed in the present embodiment that data is transmitted via a satellite, it can also be transmitted via various types of communication networks or broadcasting networks (e.g. Internet, wireless networks). Instead of transmitting data to a reception-side relay station 120 via the satellite 100, the transmission-side relay station 110 may transmit data directly to a receiving-side stadium 140. Instead of the stereo image creation apparatus, various means may be used create images and convert them into stereo image signals.

When a sport game held in a stadium is broadcasted in real time, a remote audience can watch it as if they are in the stadium. Because of the time difference or other reasons, the broadcasting station may transmit recoded data to the receiving side.

The data transmitted via the communication network or broadcasting network is received by the receiving-side relay station 120, which transmits the hologram data, which has been pre-recorded or which is broadcasted in real time, to the receiving-side station 140 in a remote area.

The receiving-side stadium 140 has an apparatus for displaying stereo images based on the received stereo moving image data, i.e. stereo image output apparatus 3, which includes a hologram output unit for outputting holograms based on hologram data and an audio output unit for outputting sounds based on sound data. The stereo image output apparatus 3 refers to synchronization information, which is included in the stereo moving image data, so as to regenerate and output hologram data and sound data. The hologram output unit includes an optical device for storing hologram data contained in the received stereo moving image data, a laser source light source unit for outputting lasers passing thorough the hologram data of the optical device, an optical panel through which the lasers are supposed to pass through after the optical device, and a device for creating stereo images by using a screen, to which beams are directed after passing through the optical panel, or other means for producing stereo images (e.g. based on scattering or interference of light). An example of an exemplary hologram creation and output units are described in detail in U.S. Pat. No. 4,566,031 (issued on Jan. 21, 1986), entitled “SPATIAL LIGHT MODULATION WITH APPLICATION TO ELECTRONICALLY GENERATED HOLOGRAPHY.” The hologram creation and output units may also be constructed as disclosed in U.S. Pat. No. 4,484,219 (issued Nov. 20, 1984), entitled “ELECTRONICALLY GENERATED HOLOGRAPHY.” The contents of both patents are incorporated by reference, herein.

By using holograms in this manner, the audience is provided with such realistic images that they feel like they are watching the game in the stadium. In the case of an event such as the World Cup 2006, many people supported their players on streets or in other stadiums while watching the game displayed on screens. In contrast to conventional methods capable of just providing planar images, the present invention can display stereo images (e.g. holograms), which simulate the movement of players, the ball, etc., together with stereo sounds simulating various sounds (e.g. whistles, cheers) in other places so that the audience can feel like they are watching the game on the spot.

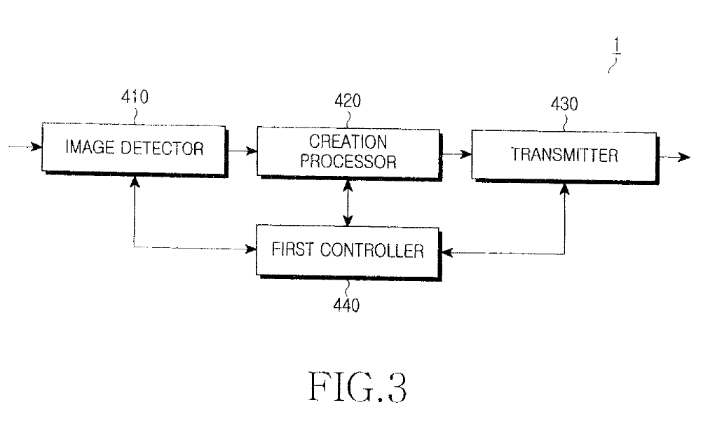

The second embodiment of the present invention is directed to a stereo image system for creating stereo moving image data by using binocular disparity. Particularly, two stereo cameras are used to take images with the same difference in viewing angles as that of human eyes, and the images are properly combined to create stereo moving image data. FIG. 3 shows the construction of a stereo image creation apparatus 1 according to an embodiment of the present invention. Referring to FIG. 3, the stereo image creation apparatus 1 includes an image detector 410, a creation processor 420, a transmitter 430, a first controller 440, and an audio unit (not shown). The image detector 410 is a camera for taking images, particularly a stereo camera. The camera may be fixedly mounted known locations in a building provided with the stereo image creation apparatus 1, as shown in FIG. 4. Alternatively, the camera may be mounted so that it can vary its position and photographing angle within a predetermined range.

When the stereo cameras are used in a stadium as shown in FIG. 4, for example, they are fixed at known locations in the stadium so as to photograph objects at various angles. The stereo image creation apparatus 1 converts data, which has been obtained by photographing objects at various angles, into stereo image data.

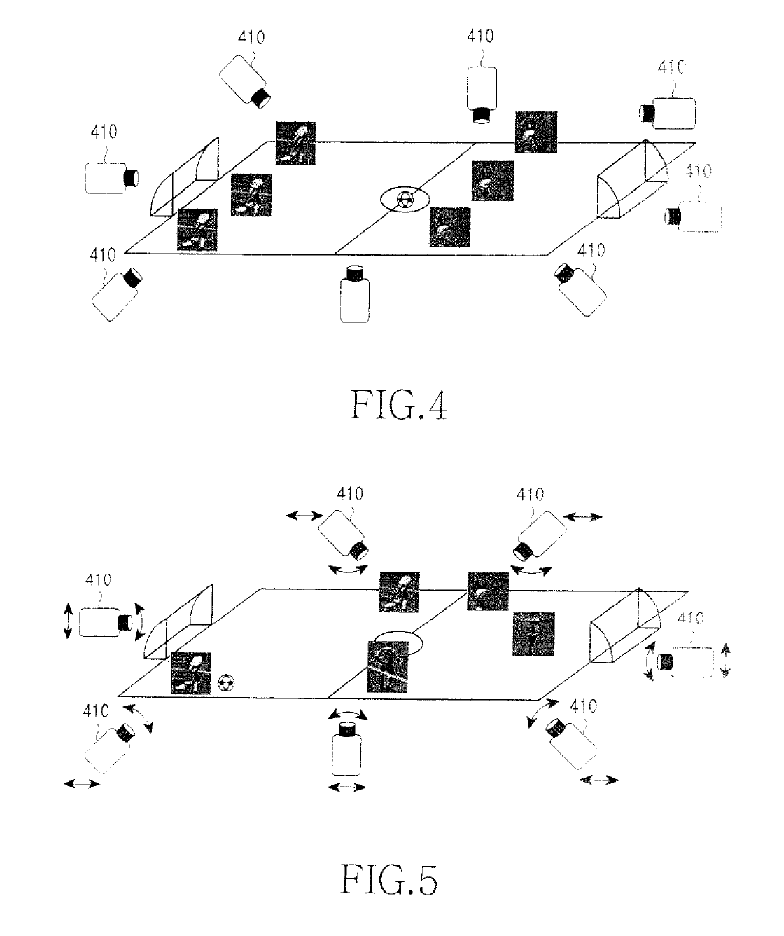

Referring to FIG. 5, stereo cameras may also be used to photograph respective players on the move. Particularly, the stereo cameras track the movement of respective players, umpires, and ball so as to pick up their images. Although not shown in the drawings, it is also possible according to an embodiment of the present invention to use various lasers to record hologram data regarding the movement of players and transmit the recorded hologram data so that, by using a regeneration device in the reception-side stadium, corresponding holograms or stereo images can be displayed.

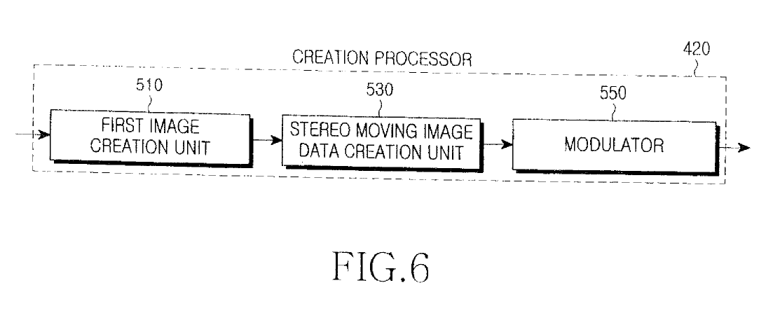

Referring to FIG. 3 again, the image detector 410, i.e. camera, obtains image data and transmits it to the creation processor 420, which processes the image data under the control of the first controller 440. Particularly, the creation processor 420 converts the image data into stereo image data and creates stereo moving image data including sound data and stereo image data, which are inputted from the first controller 440, as well as synchronization information. The sound data is created by the audio unit, which digitally processes sounds collected by a number of microphones installed at respective locations in the place where the stereo image creation apparatus 1 is used. Then, the audio unit converts the collected sounds into stereo sound data in to a multi-channel sound mode and outputs it to the first controller 440. The construction of the creation processor 420 is shown in FIG. 6. The creation processor 420 includes a first image creation unit 510, a stereo moving image data creation unit 530, and a modulator 550. Images taken by the image detector 410 (FIG. 3) are inputted to the first image creation unit 510, which creates actual image data and transmits it to the stereo moving image creation unit 530. Then, the stereo moving image creation unit 530 combines the inputted image data into stereo image data and encodes it. The combination of image data into stereo image data may follow, for example, the method disclosed in Registered Korean Patent Publication No. 10-581522, entitled “STEREO CAMERA IMAGE COMPOSITION APPARATUS,” the contents of which are incorporated by reference herein. Particularly, the odd-numbered or even-numbered pixels of image data outputted by respective cameras are selected and combined half by half. In the case of wireless transmission, the encoding is conducted by a coder, such as a turbo coder or convolutional coder. The stereo moving image creation unit 530 may additionally have data for error detection so as to prevent errors in the receiving side when stereo image data is created. In addition, the stereo moving image creation unit 530 may add information regarding the position or motion vector of cameras, which are used to obtain respective pieces of image data, to the stereo image data. When the stereo image data needs to be encrypted, the stereo moving image creation unit 530 uses a corresponding encryption key and encrypts actual data (i.e. conducts encoding in a broader sense). The encryption key for the inputted data, or parameters transmitted/received among the first controller 440, various image detectors 410, the creation processor 420, and the transmitter 430 may be transmitted via a separate channel without being added to the stereo image data. The stereo moving image creation unit 530 creates stereo moving image data including the stereo image data, sound data inputted via the first controller 440, and synchronization information, and outputs it to the modulator 550, which modulates the inputted stereo moving image data according to the transmission mode. In the case of transmission via an IP network, data including IP destination data and source data may be added during modulation. When there is a large amount of stereo image data, a compression process may be included. In the case of wireless transmission based on technology of TDMA (Time Division Multiple Access), CDMA (Code Division Multiple Access), or FDMA (Frequency Division Multiple Access), a corresponding modulation process is conducted. For example, if CMDA technology is used to transmit data wirelessly, modification can be made according to BPSK (Binary Phase Shift Keying), 8PSK (8 Phase Shift Keying), QPSK (Quadrature Phase Shift Keying), or 64QAM (64 Quadrature Amplitude Modulation). In other words, data can be modulated and suited to any type of communication network or broadcasting network capable of data transmission. The transmitter 430 transmits the stereo moving image data, which is inputted from the modulator 550, to the stereo image output apparatus 3 in the receiving-side site via the communication network 5 or broadcasting network under the control of the first controller 440.

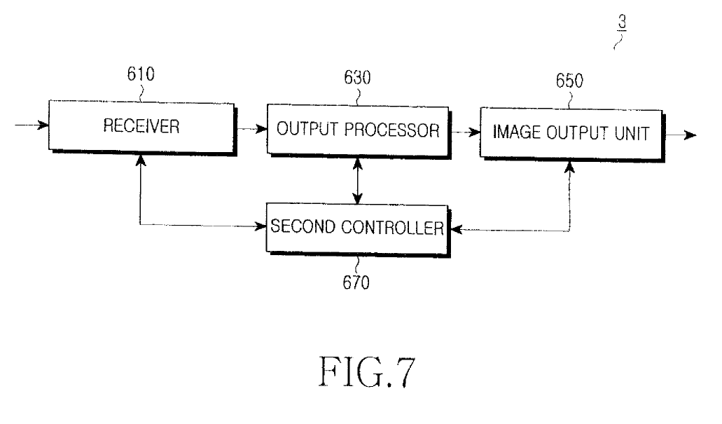

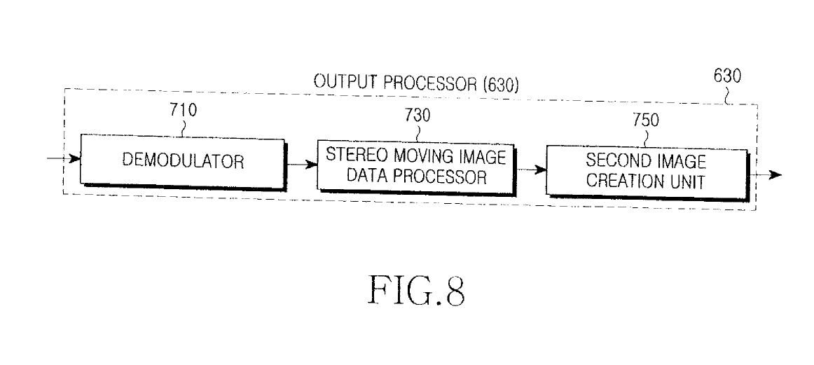

FIG. 7 shows the construction of a stereo image output apparatus 3 for receiving and outputting transmitted stereo moving image data according to an embodiment of the present invention. Referring to FIG. 7, the stereo image output apparatus 3 includes a receiver 610, an output processor 630, an image output unit 650, and a second controller 670. The receiver 610 receives stereo moving image data, which is transmitted via the communication network 5 (not shown), and transmits it to the output processor 630. When the receiver 610 has received the stereo moving image data wirelessly, it also converts the data into actual baseband signals. The output processor 630 receives the stereo moving image data and processes it. The resulting stereo image data is outputted to the image output unit 650, and sound data and synchronization information are outputted to the second controller 670 so that, under the control of the second controller 670, stereo images and sounds simulating the performance are provided in the building. FIG. 8 shows the construction of the output processor 630.

Referring to FIG. 8, the output processor 630 includes a demodulator 710, a stereo moving image data processor 730, and a second image creation unit 750. The receiver 610 receives stereo moving image data and transmits it to the demodulator 710. Based on a parameter stored in advance or transmitted from a transmission device, the demodulator 710 demodulates the stereo moving image data and outputs it to the stereo moving image data processor 730. Then, the stereo moving image data processor 730 refers to a reference parameter determined in advance or included in the stereo moving image data and divides the stereo moving image data into stereo image data, sound data, and synchronization information, which are then processed accordingly. For example, if the stereo moving image data has been encrypted, the encryption process based on an encryption key may be omitted. If the data has been compressed due to its large size, a decompression process is conducted. The stereo image data is outputted to the second image creation unit 750, and the sound data and synchronization information are outputted to the second controller 670. The second image creation unit 750 processes the stereo image data and outputs it to the image output unit 650, which is a terminal device adapted to output actual stereo images by using special projectors. Respective projectors emit lasers or visible rays into the air or onto a Transparent screen. Then, the lasers or visible rays for the projectors interfere with each other and produce stereo images in the air or onto the Transparent screen. As used herein, the Transparent screen consists of ultra-small patterns of particles floating in a transparent medium. The Transparent screen scatters, reflects, and transmits all wavelengths of light simultaneously so that images are produced in the air. The resulting images are stereo images or moving images which can be watched in any direction. Unlike conventional two-dimensional (i.e. planar) images displayed on screens, the present invention produces stereo moving images without conventional screens, i.e. in the air by using the scattering or interference of light. The second controller 670 controls a receiver 610, an output processor 630, an image output unit 650, and an audio output unit (not shown). Under the control of the second controller 670, the sound data is outputted to the audio output unit and, based on the synchronization information, corresponding stereo images and sounds are outputted via the image output unit 650 and a number of speakers, respectively. The speakers are properly positioned at the receiving-side place so that stereo sounds are outputted efficiently.

Although it has been assumed in the description of the second embodiment of the present invention that stereo image data is created according to the method disclosed in Registered Korean Patent Publication No. 10-581522, entitled “STEREO CAMERA IMAGE COMPOSITION APPARATUS,” stereo image data can be created in another method. For example, according to the disclosure in Laid-open Korean Patent Publication No. 2006-79545, entitled “THREE-DIMENSIONAL STEREO MOVING IMAGE DISPLAY APPARATUS,” the contents of which are incorporated by reference herein, various pieces of image data obtained by a number of stereo cameras are transmitted to the stereo image output apparatus 3 together with stereo image data including a combination parameter necessary to combine the image data (e.g. parameter regarding the position or movement of cameras). Then, the stereo image output apparatus 3 refers to the combination parameter so as to combine the image data and convert it into curved images. After being reflected by a reflection unit, the curved images are refracted and magnified so that stereo images are produced on the focusing surface.

As mentioned above, the present invention is advantageous in that, by creating stereo moving image data regarding a performance held in a building and transmitting data to a remote place where those who cannot partake in the performance gather, the audience are provided with substantially realistic stereo images and sounds that they feel like they are watching the performance on the spot.

While the invention has been shown and described with reference to certain exemplary embodiments thereof, it will be understood by those skilled in the art that various changes in form and details may be made therein without departing from the spirit and scope of the invention as defined by the appended claims. For example, the stereo image creation apparatus may be adapted to create two-dimensional image data and sound data, transmit them to the stereo image output apparatus, which then converts the received image data into stereo image data and outputs it together with the sound data. For another example, although it has been assumed in the above-mentioned embodiment that stereo cameras based on the binocular disparity are used, conventional cameras may be used instead to create image data, which is converted into stereo image data. Therefore, the scope of the present invention should be defined not by the description of the exemplary embodiments described herein, but by the appended claims and their equivalents.

What is claimed is:

1. A system for providing a stereo image service based on stereo images, the system comprising:
a stereo image creation device for:
converting image data created by at least one image detector into three-dimensional stereo image data,
receiving sounds collected by at least one microphone so as to create sound data from the received sounds,
creating stereo moving image data containing the stereo image data, the sound data, and synchronization information necessary to synchronize the stereo image data with the sound data, and
transmitting the stereo moving image data via at least one communication network; and
a stereo image output device for:
receiving the stereo moving image data via at least one network,
separating the stereo image data, the sound data, and the synchronization information from the stereo moving image data,
synchronizing the stereo image data with the sound data according to the synchronization information, and
outputting the stereo image data and the sound data via at least one output unit so that a performance held at a place is simulated at a remote place.

2. The system as claimed in claim 1, wherein the at least one communication network is selected from the group consisting of: a TDMA (Time Division Multiple Access) network, a CDMA (Code Division Multiple Access) network, an FDMA (Frequency Division Multiple Access) network, an IP (Internet Protocol) network, and a satellite communication network.

3. The system as claimed in claim 1, wherein the at least one image detector is a camera, and an object to be photographed is assigned to each camera so that the assigned camera senses and photographs movement of the corresponding object so as to create the image data.

4. The system as claimed in claim 1, wherein the stereo image creation device is adapted to:
modulate the moving image data according to a communication mode supported by the at least one communication network, and
transmit the stereo moving image data via the at least one communication network.

5. The system as claimed in claim 4, wherein the stereo image creation device is adapted to:
create the stereo image data in a holographic mode, and output the stereo image data in the holographic mode.

6. The system as claimed in claim 1, wherein the at least one image detector is a stereo camera, and
the stereo image creation device is adapted to combine the image data outputted from the stereo camera into the stereo image data, and
the stereo image output device is adapted to output the combined stereo image data.

7. The system as claimed in claim 6, wherein an object to be photographed is assigned to each stereo camera so that the stereo camera senses and photographs movement of the object.

8. A method for providing a stereo image service based on stereo images, the method comprising the steps of:
(a) converting image data created by at least one image detector into three-dimensional stereo image data by a stereo image creation device implemented at a first place, receiving sounds collected by at least one microphone, creating sound data from the received sounds, creating stereo moving image data containing the stereo image data, the sound data, and synchronization information necessary to synchronize the stereo image data with the sound data, and transmitting the stereo moving image data via at least one network; and
(b) receiving the stereo moving image data by a stereo image output device implemented at a second place, separating the stereo image data, the sound data, and the synchronization information from the stereo moving image data, synchronizing the stereo image data with the sound data according to the synchronization information, and outputting the stereo image data and the sound data via at least one output unit so that a performance held at the first place is simulated at the second place.

9. The method as claimed in claim 8, wherein the at least one communication network is selected from the group consisting of: a TDMA network, a CDMA network, an FDMA network, an IP network, and a satellite communication network.

10. The method as claimed in claim 9, wherein, in step (a), the stereo image creation device assigns an object to be photographed to each image detector, the image detector senses and photographs movement of the object so as to create the image data, and the image data is converted into the stereo image data.

11. The method as claimed in claim 8, wherein, in step (a), the stereo image creation device modulates the moving image data according to a communication mode supported by the at least one communication network, the stereo moving image data being transmitted via the at least one communication network.

12. The method as claimed in claim 8, wherein, in step (a), the stereo image creation device creates the stereo image data in a holographic mode and, in step (b), the stereo image output device outputs the stereo image data in the holographic mode.

13. The method as claimed in claim 8, wherein the image detector is a stereo camera, the stereo image creation device combines the image data outputted from the stereo camera into the stereo image data, and the stereo image output device outputs the combined stereo image data.

14. The system as claimed in claim 4, wherein the communication mode is a mobile communication mode.

15. The system as claimed in claim 4, wherein the communication mode is selected from the group of: a wired and wireless IP communication mode.

16. An apparatus for transmitting stereo images in a system for providing a stereo image service, the apparatus comprising:
at least one image detector;
a creation processor for:
converting image data created by the at least one image detector into three-dimensional stereo image data and
converting sounds collected by at least one microphone into sound data so as to create stereo moving image data containing the stereo image data, the sound data, and synchronization information necessary to synchronize the stereo image data with the sound data; and
a transmission device for transmitting the stereo moving image data via at least one communication network.

17. The apparatus as claimed in claim 16, wherein the at least one image detector is a camera, and an object to be photographed is assigned to each camera so that the camera senses and photographs movement of the corresponding object.

18. The apparatus as claimed in claim 16, wherein the creation processor is adapted to create stereo sound data by converting the sounds collected by the at least one microphone into stereo sounds.

19. The apparatus as claimed in claim 16, wherein the at least one image detector is a stereo camera, and the stereo image creation device is adapted to combine the image data outputted from the stereo camera into the stereo image data, and a stereo image output device is adapted to output the stereo image data.

20. The apparatus as claimed in claim 19, wherein an object to be photographed is assigned to each stereo camera so that the stereo camera senses and photographs movement of the object.

21. An apparatus for receiving stereo moving images in a system for providing a stereo image service based on stereo moving images, the apparatus comprising:
a receiver for receiving stereo moving image data via at least one communication network;
a stereo moving image data processor for separating stereo image data, sound data, and synchronization information from the stereo moving image data; and
a stereo image output device for synchronizing the stereo image data with the sound data according to the synchronization information and outputting the stereo image data and the sound data via at least one output unit.

22. The apparatus as claimed in claim 21, wherein an image output unit of the output units is a projector for outputting stereo images.

23. The apparatus as claimed in claim 22, wherein the projector is adapted to output the stereo images by using interference of lasers or visible rays.

24. The apparatus as claimed in claim 23, wherein a sound output unit of the output units is adapted to output stereo sounds when the sound data is stereo sound data.

25. A method for outputting stereo images in a system for providing a stereo image service, the method comprising the steps of:
receiving stereo moving image data via at least one communication network;
separating stereo image data, sound data, and synchronization information from the stereo moving image data; and
synchronizing the stereo image data with the sound data according to the synchronization information and outputting stereo images via at least one output unit.
